(19) United States
(12) Patent Application Publication
(10) Pub. No.: US 2026/0140766 A1
(43) Pub. Date: May 21, 2026

(54) LOAD-AWARE SCHEDULING METHOD AND DEVICE FOR INFERENCE SYSTEM, AND INFERENCE SYSTEM

(71) Applicant: Alipay (Hangzhou) Digital Service Technology Co., Ltd., Hangzhou (CN)

(72) Inventors: Zhiqiang DING, Hangzhou (CN); Tongkai YANG, Hangzhou (CN); Jun DU, Hangzhou (CN)

(21) Appl. No.: 19/389,866

(22) Filed: Nov. 14, 2025

(30) Foreign Application Priority Data
Nov. 15, 2024 (CN) 202411646359.6

(51) Int. Cl. G06F 9/48

(52) U.S. Cl. CPC G06F 9/4881

(57) ABSTRACT

A load-aware scheduling method for an inference system is applied to a global scheduler in the inference system. The inference system further includes an inference engine. The inference engine includes at least one computing instance deployed on each computing node in a computing cluster. A computing resource of the computing instance includes a GPU provided on a computing node where the computing instance is located. The global scheduler maintains dynamically updated GPU load information of each computing instance. The method includes: obtaining a target inference request to be executed; determining a target computing instance whose GPU load satisfies a predetermined condition based on the maintained GPU load information of each computing instance; and sending the target inference request to the target computing instance, to cause the target computing instance to execute the target inference request.

### CROSS-REFERENCE TO RELATED APPLICATIONS

This application claims priority to Chinese Patent Application No. 202411646359.6, filed on Nov. 15, 2024, the entire content of which is incorporated herein by reference.

### TECHNICAL FIELD

The present disclosure relates to the field of artificial intelligence technologies, and in particular, to a load-aware scheduling method and device for an inference system, and an inference system.

### BACKGROUND

Inference systems are systems that use logical rules and known facts to derive new conclusions or decisions by, e.g., executing computer programs. The inference systems are an important component in the field of artificial intelligence, and are mainly used to simulate human decision-making processes. The inference systems derive conclusions based on a group of defined knowledge bases and inference engines. The inference systems can execute inference requests obtained by the inference systems, and output corresponding inference results.

A typical inference system generally includes the following several parts: a knowledge base, an inference engine, a user interface, and an explanation facility. The knowledge base includes all the facts and rules known to the system. These facts can be about world states, object properties, etc., while the rules are logical expressions describing how to derive new conclusions from known facts. The inference engine is a core component of the inference system, and is responsible for performing logical operations in an inference process, i.e., deriving new conclusions or decisions from a given knowledge base. The inference engine uses a series of rules and known facts to infer new knowledge, thereby helping the system solve problems or make decisions. The user interface allows users to interact with the system, input queries, or observe results of the inference process. The explanation facility is used to explain how the system derives a specific conclusion, which is crucial for transparency and trust.

When large-scale data processing, high-concurrency request processing, or high-performance computing is needed, the inference engine is generally deployed on a computing cluster. Deploying the inference engine on the computing cluster can implement higher computing capability, better fault tolerance, and more flexible resource management. However, this introduces the problem of how to schedule inference requests on the cluster-level inference engine.

### SUMMARY

A first aspect of the present disclosure provides a load-aware scheduling method for an inference system. The method is applied to a global scheduler in the inference system; the inference system further includes an inference engine; the inference engine includes at least one computing instance deployed on each computing node in a computing cluster; a computing resource of the computing instance includes a GPU provided on a computing node where the computing instance is located; the global scheduler maintains dynamically updated GPU load information of each computing instance; and the method includes: obtaining a target inference request to be executed; determining a target computing instance whose GPU load satisfies a predetermined condition based on the maintained GPU load information of each computing instance; and sending the target inference request to the target computing instance, to cause the target computing instance to execute the target inference request.

A second aspect of the present disclosure provides an electronic device including a processor; and a memory storing instructions executable by the processor. The processor implements a global scheduler in an inference system; the inference system further includes an inference engine; the inference engine includes at least one computing instance deployed on each computing node in a computing cluster; a computing resource of the computing instance includes a GPU provided on a computing node where the computing instance is located; the global scheduler maintains dynamically updated GPU load information of each computing instance; and the processor is configured to: obtain a target inference request to be executed; determine a target computing instance whose GPU load satisfies a predetermined condition based on the maintained GPU load information of each computing instance; and send the target inference request to the target computing instance, to cause the target computing instance to execute the target inference request.

A third aspect of the present disclosure provides an inference system. The inference system includes a global scheduler and an inference engine, where the inference engine includes at least one computing instance deployed on each computing node in a computing cluster; a computing resource of the computing instance includes a GPU provided on a computing node where the computing instance is located; the global scheduler maintains dynamically updated GPU load information of each computing instance; and the global scheduler is configured to: obtain a target inference request to be executed; determine a target computing instance whose GPU load satisfies a predetermined condition based on the maintained GPU load information of each computing instance; and send the target inference request to the target computing instance, to cause the target computing instance to execute the target inference request.

In embodiments of the present disclosure, the inference engine in the inference system can include at least one computing instance deployed on each computing node in the computing cluster. The computing resource of each computing instance can include a GPU provided on a computing node where the computing instance is located. The global scheduler in the inference system can maintain dynamically updated GPU load information of each computing instance. When obtaining the target inference request to be executed, the global scheduler can first determine a target computing instance whose GPU load satisfies the predetermined condition based on the maintained GPU load information of each computing instance, and then send the target inference request to the target computing instance, so that the target computing instance executes the target inference request, thereby achieving scheduling for the target inference request.

As such, a global scheduler is added to an inference system, so that an inference request can be scheduled by the global scheduler to a computing instance with appropriate GPU load in an inference engine for execution, thereby implementing load-aware scheduling of the inference request on the cluster-level inference engine, which optimizes GPU resource usage efficiency, reduces waiting time and processing latency for inference request execution, and improves overall throughput of the inference system. In addition, the inference request is scheduled to the inference engine by the global scheduler, rather than being scheduled directly in the inference engine, thereby decoupling a scheduling method from a specific inference engine, and providing universality and extensibility.

### BRIEF DESCRIPTION OF DRAWINGS

FIG. 1 is a schematic diagram illustrating an inference system, according to an example embodiment.

FIG. 2 is a schematic diagram illustrating an inference system, according to an example embodiment.

FIG. 3 is a flowchart illustrating a load-aware scheduling method for an inference system, according to an example embodiment.

FIG. 4 is a schematic structural diagram of a device, according to an example embodiment.

FIG. 5 is a block diagram illustrating an inference system, according to an example embodiment.

### DETAILED DESCRIPTION OF EMBODIMENTS

Example embodiments are described in detail here, and examples of the example embodiments are represented in the accompanying drawings. When the following description relates to the accompanying drawings, unless specified otherwise, the same numbers in different accompanying drawings represent the same or similar elements. Implementations described in the following example embodiments do not represent all implementations consistent with one or more embodiments in this disclosure. On the contrary, the implementations are merely examples consistent with some aspects of one or more embodiments of this disclosure.

It is worthwhile to note that steps of a described method are not necessarily performed based on a sequence shown and described in this disclosure. In some other embodiments, the method can include more or fewer steps than those described in this disclosure. In addition, a single step described in this disclosure may be split into a plurality of steps in other embodiments; and a plurality of steps described in this disclosure may be combined into a single step in other embodiments.

In this disclosure, an inference engine in an inference system can be deployed on a computing cluster to satisfy needs for large-scale data processing, high-concurrency request processing, or high-performance computing, thereby implementing higher computing capability, better fault tolerance, and more flexible resource management. In such inference systems, load-aware scheduling can be used to schedule inference requests on the cluster-level inference engines.

Load-aware scheduling refers to a strategy for allocating tasks in a computing system based on current load conditions of nodes or resources. This scheduling method aims to optimize resource usage efficiency, reduce waiting time and processing latency, and improve overall throughput of the system.

Load-aware scheduling is generally applied in scenarios such as distributed systems, cloud computing platforms, and data centers, with the purpose of dynamically balancing workloads of nodes and alleviating situations where some nodes are overloaded while others are idle. By monitoring the load conditions of the nodes in real time, a load-aware scheduler can make more reasonable task allocation decisions.

The inference engines can use central processing units (CPUs) as computing resources, where the CPUs can be CPUs provided on devices used to deploy the inference engines. CPU utilization and memory utilization are generally selected as load indicators of the CPUs. That is, for inference engines deployed on computing clusters, calculating CPU utilization and memory utilization to represent load conditions of the CPUs can achieve load-aware scheduling of inference requests on such inference engines.

With continuous development of artificial intelligence technologies, inference systems based on large models (e.g., large language models) are becoming increasingly widespread.

Large models refer to machine learning models with a large number of parameters, such as variants under the Transformer architecture, including but not limited to natural language processing models such as GPT and BERT. These models achieve powerful representational learning capabilities through a large amount of training data and complex architectures.

In inference systems based on large models, the large model can be considered as a huge knowledge base, which contains information learned from a large amount of data. The large model learns a large number of patterns and features in a training process, and these patterns and features represent complex relationships in the data. Therefore, to some extent, the information stored in the large model can be considered as a form of knowledge.

The inference engine designed for the large model is responsible for invoking the large model to perform specific inference work, that is, capable of managing loading of the large model, executing inference operations of the large model, and managing interactions with hardware (e.g., CPU, GPU, or other accelerators). The inference engine can further include an optimization algorithm to improve speed and efficiency of inference.

In some embodiments, the large model can be deployed separately from the inference system. Alternatively, the large model can be integrated into the inference system, and an inference engine in the inference system is used to invoke the large model to efficiently perform an inference task.

Because the large model is an artificial intelligence application that needs a large number of computing resources, the inference engine can use a graphics processing unit (GPU) as the computing resource when invoking the large model to perform the inference task.

The GPU is specially designed for parallel processing and can process a plurality of data points simultaneously. This is especially useful for deep learning models because the deep learning models often need to perform the same operations on a large amount of data. Modern artificial intelligence (AI) models, especially neural network models, need a large number of floating-point operations. Performance of GPUs is generally better than that of CPUs in floating-point operations, especially when processing large-scale matrix operations, which are common in deep learning. GPUs usually have higher memory bandwidth than CPUs, which means that GPUs can read from memory and write data to memory faster. This is very important for applications that need frequent access to a large amount of data. Many GPU vendors have optimized hardware and software stacks of the GPU vendors for machine learning tasks. For example, the GPU vendors provide hardware specifically designed to accelerate tensor operations, and programming models such as CUDA to fully utilize these hardware features. GPUs can improve an inference speed. For large-scale deployed applications, using GPUs can reduce latency and improve a response speed of the system.

Example GPU load indicators include SM Clock (Streaming Multiprocessor Clock), SM Activity (Streaming Multiprocessor Activity), Memory Utilization (Memory Usage), etc. SM Clock refers to a clock frequency of a streaming multiprocessor on the GPU. The streaming multiprocessor is a computing unit on the GPU, and is responsible for executing parallel computing tasks. A higher SM Clock frequency means that the computing unit of the GPU runs faster, which generally leads to higher computing performance but may also increase power consumption and heat. SM Activity refers to a degree of activity (i.e., a proportion of time these computing units are actually executing tasks over a period) of the streaming multiprocessor on the GPU. If the SM Activity is high, it means that the computing unit of the GPU is actively working most of the time. Conversely, if the SM Activity is low, it may mean that computing bottlenecks exist or waiting time is relatively long. Memory Utilization refers to usage of GPU video memory, and generally represents a proportion of currently used video memory in total video memory. Higher Memory Utilization means that more video memory is occupied, which may lead to slower data exchange speeds or affect performance due to insufficient video memory. When the video memory is nearly full, data may be triggered to spill over to host memory, which will further reduce performance.

For inference engines deployed on computing clusters, calculating the load indicators of the GPUs to represent the load conditions of the GPUs can achieve load-aware scheduling of inference requests on such inference engines.

In embodiments of this disclosure, the inference engine in the inference system can include at least one computing instance deployed on each computing node in the computing cluster. The computing resource of each computing instance can include a GPU provided on a computing node where the computing instance is located. The global scheduler in the inference system can maintain dynamically updated GPU load information of each computing instance. When obtaining the target inference request to be executed, the global scheduler can first determine a target computing instance whose GPU load satisfies the predetermined condition based on the maintained GPU load information of each computing instance, and then send the target inference request to the target computing instance, so that the target computing instance executes the target inference request, thereby achieving scheduling for the target inference request.

As such, a global scheduler is added to an inference system, so that an inference request can be scheduled by the global scheduler to a computing instance with appropriate GPU load in an inference engine for execution, thereby implementing load-aware scheduling of the inference request on the cluster-level inference engine, which optimizes GPU resource usage efficiency, reduces waiting time and processing latency for inference request execution, and improves overall throughput of the inference system. In addition, the inference request is scheduled to the inference engine by the global scheduler, rather than being scheduled directly in the inference engine, thereby decoupling a scheduling method from a specific inference engine, and providing certain universality and extensibility.

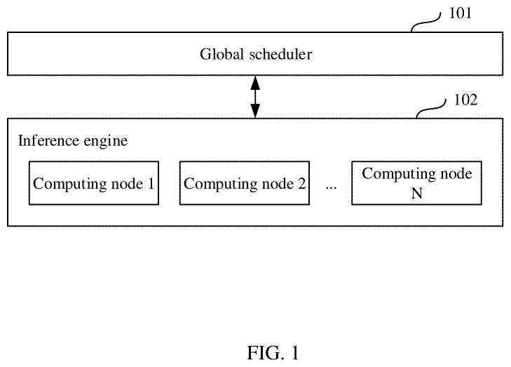

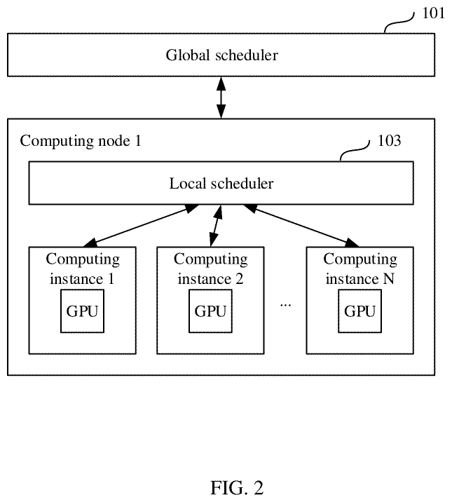

Referring to FIG. 1 and FIG. 2, FIG. 1 and FIG. 2 are schematic diagrams of an inference system according to an example embodiment of this disclosure, respectively.

As shown in FIG. 1, the inference system can include a global scheduler 101 and an inference engine 102. The inference engine 102 can be deployed on a computing cluster composed of at least one computing node, such as computing nodes 1-N.

The computing cluster is a system where a plurality of computers or servers are connected via a network to work together. These nodes jointly complete a computing task, and provide a stronger computing capability and higher availability than a single computer. The computing node is one of core components of the computing cluster, and generally refers to a computer or server used to perform a compute-intensive task. The computing node can undertake a computing task, and a GPU provided on the computing node can serve as a computing resource. The computer or server can be a physical or virtual local computer or local server, or a physical or virtual cloud computer or cloud server.

In some embodiments, the global scheduler 101 can be deployed on a head node in the computing cluster, where the head node generally refers to a node responsible for management and scheduling of the computing cluster. Alternatively, the global scheduler 101 can be deployed on another computing device outside the computing cluster. Implementations are not limited in this disclosure.

In the inference system, the global scheduler 101 and the inference engine 102 can communicate with each other, for example, by using an HTTP (Hypertext Transfer Protocol) protocol directly.

For example, the global scheduler 101 can communicate with applications and components deployed on each computing node in the computing cluster. In this case, the global scheduler 101 can obtain an inference request from a request queue, select a computing node whose GPU load condition is appropriate based on the load conditions of the GPUs provided on each computing node, and schedule the obtained inference request to the computing node to use the GPU provided on the computing node to execute the inference request.

As shown in FIG. 2, for each computing node in the computing cluster, at least one computing instance can be deployed on the computing node. A computing instance refers to a dedicated resource allocated according to needs through virtualization technology in a local data center or cloud computing platform. The resources of these computing instances can include computing resources, storage resources, network resources, etc. (e.g., GPU, GPU memory, storage, and network interface), so that each computing instance can use these resources to perform a specific computing task. The computing instances can be created, started, stopped, or deleted according to actual needs, and the resources of the computing instances can be adjusted according to needs.

In a large model-oriented inference engine, a computing resource of a computing instance can be a GPU of a computing node where the computing instance is located.

In some embodiments, a computing node can be equipped with a plurality of GPUs, and a GPU can be allocated to a computing instance as a computing resource of the computing instance. Alternatively, a computing node may be equipped with only one GPU, and a computing resource allocated to a computing instance can be a part of a computing unit, memory, etc. of the GPU.

In the large model-oriented inference engine, each computing instance can invoke the large model to perform specific inference work, that is, the large model can be loaded into each computing instance, so that each computing instance executes an inference operation of the large model. Specifically, the large model can be read from a local or cloud storage medium (e.g., local disk, and cloud storage) into the GPU memory of each computing instance, to perform inference on the GPU computing resource of each computing instance based on the large model.

In some embodiments, a model runtime framework can be installed in the computing instance, and after reading the large model into the computing instance, a model service can be configured based on the model runtime framework and the large model, so that the computing instance can serve as an independently runnable model service instance. Model runtime refers to an environment and a framework used to execute model inference after the model is deployed. The environment generally includes a series of steps such as model loading, input data processing, model execution, and output result processing, covering an entire lifecycle of the model from loading to execution to unloading.

By deploying computing instances on computing nodes, firstly, resources of the computing nodes can be fully utilized to accelerate execution of computing tasks, thereby improving computing capabilities of inference engines; secondly, different computing instances are independent of each other, thereby ensuring stability and security of the computing tasks, and implementing resource isolation and management, which facilitates effective resource utilization and alleviates resource contention; thirdly, for computing tasks that need parallel processing, parallel computing can be used to accelerate completion time of the computing tasks; and fourthly, elastic scaling can be achieved: when a large number of computing tasks need to be processed, computing instances can be added, and when the number of computing tasks to be processed decreases, some computing instances can be terminated to release some resources, thereby achieving flexible resource allocation.

To facilitate load-aware scheduling of the inference request, the global scheduler 101 can maintain the GPU load information of each computing instance, where the GPU load information can indicate the load condition of the GPU. In this case, the global scheduler 101 can obtain an inference request from a request queue, select a computing instance whose GPU load condition is appropriate based on the maintained GPU load information of each computing instance, and schedule the obtained inference request to the computing instance to use the GPU serving as the computing resource of the computing node to execute the inference request.

It is worthwhile to note that the GPU load information that is of each computing instance and that is maintained by the global scheduler 101 can be dynamically updated. For example, after a certain inference request is scheduled to a certain computing instance and the computing instance starts to execute the inference request, GPU load information can be generated based on a current GPU load condition of the computing instance, the generated GPU load information is reported to the global scheduler 101, and the previously maintained GPU load information of the computing instance is updated by the global scheduler 101 based on the GPU load information.

For each computing node in the computing cluster, to facilitate maintenance, management, and scheduling of a computing instance deployed on the computing node, a local scheduler 103 can also be deployed on the computing node, such as computer node 1 in FIG. 2.

The global scheduler can communicate with a local scheduler deployed on each computing node in the computing cluster. In this case, the global scheduler can obtain an inference request from a request queue, select a computing instance whose GPU load condition is appropriate based on the maintained GPU load information of each computing instance, and schedule the obtained inference request to a local scheduler deployed on a computing node where the computing instance is located, and the local scheduler further schedules the inference request to the computing instance to use the GPU serving as the computing resource of the computing node to execute the inference request.

In some embodiments, to ensure reliability and correctness of inference request scheduling, for each local scheduler, the local scheduler can maintain a sequential queue. The sequential queue can be a first-in-first-out (FIFO) sequence of inference requests, that is, the inference requests in the sequential queue are processed in the order the inference requests enter the sequential queue.

In addition, for each computing node in the computing cluster, the local scheduler deployed on the computing node can monitor the GPU load condition of each computing instance deployed on the computing node, generate corresponding GPU load information, and report the generated GPU load information to the global scheduler, so that the global scheduler can maintain dynamically updated GPU load information of each computing instance.

In some embodiments, the global scheduler can include two components: a request router component responsible for routing inference requests, and a load manager component responsible for obtaining and maintaining the GPU load information of all computing instances.

For each local scheduler, the local scheduler can include two components: a load manager component responsible for computing the GPU load information of all computing instances deployed on a computing node where the local scheduler is located, and a monitor component responsible for monitoring operation related information (e.g., GPU memory utilization, GPU memory bandwidth utilization, the number of inference requests waiting in the sequential queue, and the number of running inference requests) of all computing instances deployed on the computing node where the local scheduler is located.

For each computing instance, the computing instance can include two components: a cache engine component used to cache inference results to alleviate repeated computation, and an executor component responsible for invoking the large model to execute the inference task corresponding to the inference request.

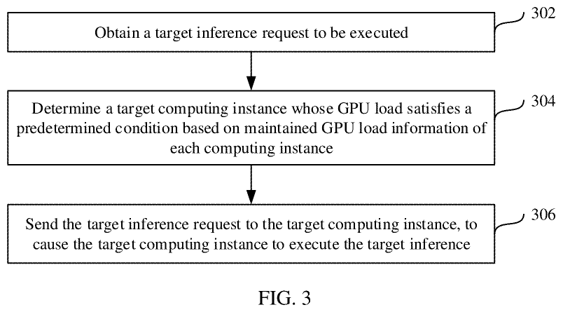

FIG. 3 is a flowchart illustrating a load-aware scheduling method for an inference system according to an example embodiment of this disclosure. For example, the load-aware scheduling method can be applied to the global scheduler 101 shown in FIG. 1.

As shown in FIG. 3, the load-aware scheduling method can include the following steps:

Step 302: Obtain a target inference request to be executed.

In an embodiment, the global scheduler can first obtain an inference request (which can be referred to as the target inference request) to be executed. For example, the global scheduler can sequentially obtain inference requests from a request queue used to temporarily store all inference requests to be executed, as the target inference request.

Step 304: Determine a target computing instance whose GPU load satisfies a predetermined condition based on the maintained GPU load information of each computing instance.

In an embodiment, as described above, the global scheduler can maintain the GPU load information of each computing instance, and the GPU load information can indicate the load condition of the GPU. In this case, the global scheduler can determine a computing instance (which can be referred to as the target computing instance) whose GPU load satisfies the predetermined condition based on the maintained GPU load information of each computing instance.

In some embodiments, the computing instance whose GPU load satisfies the predetermined condition can be a computing instance with the smallest GPU load.

Step 306: Send the target inference request to the target computing instance, to cause the target computing instance to execute the target inference request.

In an embodiment, after determining the target computing instance, the global scheduler can send the target inference request to the target computing instance via a communication connection between the global scheduler and the inference engine, so that the target computing instance executes the target inference request. That is, the global scheduler can schedule the target inference request to the target computing instance whose GPU load satisfies the predetermined condition, thereby implementing load-aware scheduling of the inference request on the cluster-level inference engine, which optimizes GPU resource usage efficiency, reduces waiting time and processing latency for inference request execution, and improves overall throughput of the inference system.

In some embodiments, when maintaining the GPU load information of each computing instance, the global scheduler can associatively store instance information of each computing instance and the GPU load information, thereby locating the target computing instance based on the instance information of the determined target computing instance whose GPU load satisfies the predetermined condition, and sending the target inference request to the target computing instance.

In some embodiments, as described above, the inference engine can further include a local scheduler deployed on each computing node in the computing cluster, in addition to including at least one computing instance deployed on each computing node in the computing cluster. Correspondingly, when sending the target inference request to the target computing instance, the target inference request can be specifically sent to a target local scheduler, so that the target local scheduler sends the target inference request to the target computing instance, where the target local scheduler is specifically a local scheduler deployed on a computing node where the target computing instance is located.

In some embodiments, to make dynamic update of the GPU load information that is of each computing instance and that is maintained by the global scheduler easy to implement, accurate, and reliable, for each computing node in the computing cluster, the local scheduler deployed on the computing node can periodically collect the GPU load information of each computing instance deployed on the computing node (for example, generate the GPU load information based on the current GPU load condition of the computing instance) based on a predetermined time period, and report the collected GPU load information to the global scheduler, so that the global scheduler can update the maintained GPU load information of each computing instance deployed on the computing node based on the GPU load information reported by the local scheduler.

In some embodiments, the GPU load information can specifically be represented as instance resource utilization. It is worthwhile to note that, for each computing instance, the instance resource utilization of the computing instance can be an indicator used to indicate the GPU load, and the indicator can specifically be an indicator calculated by the local scheduler deployed on the computing node where the computing instance is located, based on the GPU memory utilization and the GPU memory bandwidth utilization of the computing instance. The GPU memory utilization can be obtained by reading hardware information of the GPU, and the GPU memory bandwidth utilization can be obtained through a data center GPU manager (DCGM) service. In this case, when determining the target computing instance whose GPU load satisfies the predetermined condition based on the maintained GPU load information of each computing instance, the target computing instance with the smallest instance resource utilization can specifically be determined based on the maintained GPU load information of each computing instance.

In some embodiments, the GPU memory utilization can be utilization of memory blocks in the GPU. A block refers to a group of threads that can be organized together for ease of management and communication. All threads in a block can cooperate to perform certain operations and can use shared memory to facilitate this cooperation. Each block can access a specific number of shared memories and other resources. Therefore, the number of blocks and the number of threads in each block together determine the total amount of resources used.

It is worthwhile to note that, when a certain inference request is scheduled, if the inference request is an inference request in a prefill stage in the inference process of the large model, the block utilization can specifically be the number of blocks needed by a prompt of the large model. If the inference request is an inference request in a decode stage in the inference process of the large model, the block utilization can specifically be actual GPU memory utilization.

In the inference process of the large model (especially a generative model in natural language processing), the prefill stage and the decode stage refer to different steps in text generation.

In the prefill stage, the model generally generates an initial text segment, which includes a starting part of a generated sequence. The goal of the prefill stage is to provide a good starting point for subsequent generation. This stage may involve using some predefined strategies or algorithms to select the most appropriate starting words or phrase. For example, when processing a conditional generation task, the model may first generate part of the text as a basis based on an input condition (e.g., summary generation and question answering).

In the decode stage, a main process of text generation is that the model generates new content word by word on the basis of the existing text. In each iteration, the model predicts a next most likely word and adds the word to a current text sequence. This process continues until a predetermined end condition (for example, reaching the maximum length, or generating an end-of-text marker) is reached. The decode stage may use various strategies to optimize quality of generation, e.g., Top-k sampling, Top-p sampling (also referred to as nucleus sampling), and other technologies. These technologies can help the model alleviate generation of too ordinary or meaningless content.

In some embodiments, the prefill and decode stages are closely connected. The prefill stage provides an initial text basis, and the decode stage is responsible for gradually expanding on this basis to generate the complete text output. These two stages together determine quality and coherence of a final generated text.

In some embodiments, the instance resource utilization can be calculated based on the GPU memory utilization and the GPU memory bandwidth utilization of the computing instance by using the following formula:

$${U}_{Instance} = - 1 \times \frac{{M}_{Instance} - {U}_{Composite}}{Speed} ;$$

$${U}_{Composite} = {U}_{GPU} \times a ;$$

$$a = \{ \begin{matrix}1 + α \times \frac{t - {U}_{BW}}{t - min ( {U}_{BW} )} \\ 1 - β \times \frac{{U}_{BW} - t}{max ( {U}_{BW} ) - t}\end{matrix} ;$$

where U_{Instance} represents the instance resource utilization of the computing instance, M_{Instance} represents a total GPU memory size of the computing instance, U_{Composite} represents composite load of the computing instance, Speed represents the number of tokens generated by the computing instance in each iteration, U_{GPU} represents the GPU memory utilization of the computing instance, α represents a composite coefficient, α represents a predetermined first control coefficient, β represents a predetermined second control coefficient, α>β, t represents a predetermined second threshold, and U_{BW} represents the GPU memory bandwidth utilization of the computing instance.

Through the composite load, the GPU memory utilization and the GPU memory bandwidth utilization can be combined for load-aware scheduling. In practical application scenarios, the GPU memory bandwidth utilization is negatively correlated with the GPU memory utilization. To prevent a sharp decline in data access performance between GPU memory and main memory due to excessively high GPU memory bandwidth utilization, a threshold (i.e., the second threshold) can be set for the GPU memory bandwidth utilization. When the GPU memory bandwidth utilization is below the threshold, increasing the GPU memory bandwidth utilization is preferred, thereby obtaining a larger composite load. When the GPU memory bandwidth utilization exceeds the threshold, increasing the GPU memory utilization and reducing the GPU memory bandwidth utilization are preferred, thereby obtaining a smaller composite load. As such, lower GPU memory bandwidth utilization can be maintained while increasing the GPU memory utilization.

The α and β are both control coefficients that can be obtained through experiments, and are used to control response sensitivity to α. A value of α should be greater than a value of β, indicating expecting to increase the GPU memory bandwidth utilization when the GPU memory bandwidth utilization is below the threshold.

The Speed can represent the number of new tokens generated for all inference requests in each iteration (Tokens Generated Per Iteration). Therefore,

$$\frac{{M}_{Instance} - {U}_{Composite}}{Speed}$$

can represent how many iterations are needed to consume the remaining GPU memory of the computing instance at a current token generation rate. It can be seen that the smaller the instance resource utilization of the computing instance, the more number of iterations the remaining GPU memory of the computing instance can support, and the smaller the load of the computing instance; the larger the instance resource utilization of the computing instance, the fewer number of iterations the remaining GPU memory of the computing instance can support, and the larger the load of the computing instance. That is, a load size of the computing instance is positively correlated with the instance resource utilization.

It is worthwhile to note that the inference process of the large model refers to a process of using a pre-trained large machine learning model to generate corresponding output results based on given input data (i.e., the data included in the inference request). In the field of natural language processing, especially in large language models, the inference process generally involves generating a continuous text sequence based on a given input prompt, and a token is generated in each iteration. The token here generally refers to a series of small units into which the text is split in natural language processing, such as a word or character, depending on a segmentation method of the model. Specifically, a segment of text can be provided to the model as input, and this segment of text is referred to as a prompt; the model receives this prompt and converts the prompt into a form that can be processed internally, generally by converting each word into a corresponding numerical representation (e.g., word embedding); based on a current prompt, the model predicts a next most likely token through complex calculations (e.g., multi-layer neural network operations); and the model adds the predicted token to the end of the existing prompt to form a new prompt. The above steps can be repeated a plurality of times, and each repetition is referred to as an iteration. In each iteration, the model predicts a next token based on a latest prompt until a set stopping condition (e.g., generating a certain number of tokens or encountering a specific end marker) is reached.

In some embodiments, the GPU load information can further include the GPU memory utilization. When determining the target computing instance with the smallest instance resource utilization based on the maintained GPU load information of each computing instance, the global scheduler can specifically first determine candidate computing instances (which can be referred to as candidate computing instances) whose GPU memory utilization is less than a predetermined threshold (which can be referred to as a first threshold) based on the maintained GPU load information of each computing instance, and then sort the candidate computing instances based on the instance resource utilization to determine the target computing instance with the smallest instance resource utilization from the candidate computing instances. As such, this can reduce the number of comparisons of GPU load sizes for different computing instances when the global scheduler determines the target computing instance whose GPU load satisfies the predetermined condition based on the maintained GPU load information of each computing instance, and improve selection efficiency of the target computing instance, thereby improving scheduling efficiency.

In some embodiments, when a computing instance is in a termination process, the instance resource utilization of the computing instance can be set to infinity, thereby alleviating scheduling of the inference request to the computing instance that is in the termination process.

In the above embodiments, the inference engine in the inference system can include at least one computing instance deployed on each computing node in the computing cluster. The computing resource of each computing instance can include a GPU provided on a computing node where the computing instance is located. The global scheduler in the inference system can maintain dynamically updated GPU load information of each computing instance. When obtaining the target inference request to be executed, the global scheduler can first determine a target computing instance whose GPU load satisfies the predetermined condition based on the maintained GPU load information of each computing instance, and then send the target inference request to the target computing instance, so that the target computing instance executes the target inference request, thereby achieving scheduling for the target inference request.

As such, a global scheduler is added to an inference system, so that an inference request can be scheduled by the global scheduler to a computing instance with appropriate GPU load in an inference engine for execution, thereby implementing load-aware scheduling of the inference request on the cluster-level inference engine, which optimizes GPU resource usage efficiency, reduces waiting time and processing latency for inference request execution, and improves overall throughput of the inference system. In addition, the inference request is scheduled to the inference engine by the global scheduler, rather than being scheduled directly in the inference engine, thereby decoupling a scheduling method from a specific inference engine, and providing certain universality and extensibility.

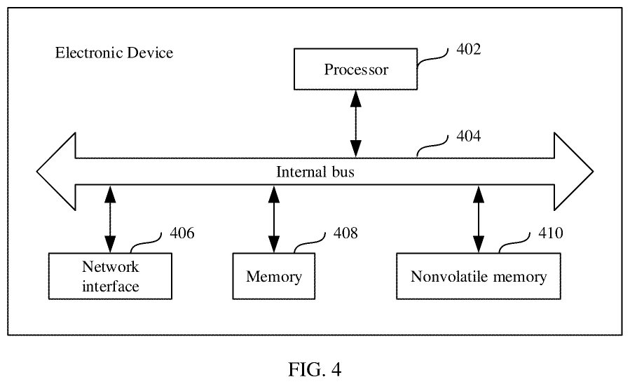

FIG. 4 is a schematic structural diagram of a device according to an example embodiment of this disclosure. The device includes a processor 402 and a memory 408 storing instructions executable by the processor 402, and may also include an internal bus 404, a network interface 406, a nonvolatile memory 410, or other needed hardware. The processor 402 is configured to perform the above-described load-aware scheduling method for the inference system. For example, the processor 402 reads a corresponding computer program from the nonvolatile memory 410 to the memory 408, and then runs the computer program. Also for example, the device may be implemented by a logic device or a combination of software and hardware.

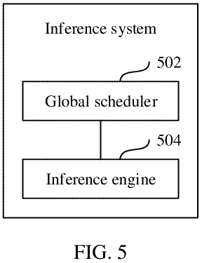

FIG. 5 is a block diagram illustrating an inference system according to an example embodiment of this disclosure. For example, the inference system can be applied to the device shown in FIG. 4 to implement the technical solution of this disclosure. The inference system includes a global scheduler 502 and an inference engine 504. The inference engine 504 includes at least one computing instance deployed on each computing node in a computing cluster. A computing resource of the computing instance includes a GPU provided on a computing node where the computing instance is located. The global scheduler maintains dynamically updated GPU load information of each computing instance.

The global scheduler 502 is configured to: obtain a target inference request to be executed; determine a target computing instance whose GPU load satisfies a predetermined condition based on the maintained GPU load information of each computing instance; and send the target inference request to the target computing instance, to cause the target computing instance to execute the target inference request.

In some embodiments, the predetermined condition is that GPU load of the computing instance is the lowest.

In some embodiments, the inference engine further includes a local scheduler deployed on each computing node in the computing cluster; and the sending the target inference request to the target computing instance includes: sending the target inference request to a target local scheduler, so that the target local scheduler sends the target inference request to the target computing instance, where the target local scheduler is a local scheduler deployed on a computing node where the target computing instance is located.

In some embodiments, the global scheduler is further configured to: for each computing node, obtain GPU load information of each computing instance on the computing node that is periodically sent by the local scheduler on the computing node based on a predetermined time period; and update the maintained GPU load information of each computing instance based on the obtained GPU load information.

In some embodiments, the GPU load information includes instance resource utilization, where the instance resource utilization is an indicator that is calculated by the local scheduler based on GPU memory utilization and GPU memory bandwidth utilization of the computing instance and that is used to indicate GPU load; and the determining the target computing instance whose GPU load satisfies a predetermined condition based on the maintained GPU load information of each computing instance includes: determining the target computing instance with the smallest instance resource utilization based on the maintained GPU load information of each computing instance.

In some embodiments, the GPU load information further includes GPU memory utilization; and the determining the target computing instance with the smallest instance resource utilization based on the maintained GPU load information of each computing instance includes: determining a candidate computing instance whose GPU memory utilization is less than a predetermined first threshold based on the maintained GPU load information of each computing instance; and sorting the candidate computing instances based on the instance resource utilization to determine the target computing instance with the smallest instance resource utilization from the candidate computing instances.

In some embodiments, the instance resource utilization can be calculated based on the GPU memory utilization and the GPU memory bandwidth utilization of the computing instance by using the following formula:

$${U}_{Instance} = - 1 \times \frac{{M}_{Instance} - {U}_{Composite}}{Speed} ;$$

$${U}_{Composite} = {U}_{GPU} \times a ;$$

$$a = \{ \begin{matrix}1 + α \times \frac{t - {U}_{BW}}{t - min ( {U}_{BW} )} \\ 1 - β \times \frac{{U}_{BW} - t}{max ( {U}_{BW} ) - t}\end{matrix} ;$$

where U_{Instance} represents the instance resource utilization of the computing instance, M_{Instance} represents a total GPU memory size of the computing instance, U_{Composite} represents composite load of the computing instance, Speed represents the number of tokens generated by the computing instance in each iteration, U_{GPU} represents the GPU memory utilization of the computing instance, α represents a composite coefficient, α represents a predetermined first control coefficient, β represents a predetermined second control coefficient, α>β, t represents a predetermined second threshold, and U_{BW} represents the GPU memory bandwidth utilization of the computing instance.

In some embodiments, the instance resource utilization of the computing instance is set to infinity when the computing instance is in a termination process.

The apparatus embodiments basically correspond to the method embodiments. Therefore, for related parts, references can be made to relevant descriptions in the method embodiments. The described apparatus embodiments are merely examples. The modules described as separate parts may or may not be physically separate, and parts displayed as modules may or may not be physical modules, that is, may be located at one position, or may be distributed on a plurality of network modules. Some or all of the modules or units can be selected based on actual needs to achieve the objectives of the technical solutions of this disclosure.

The system, apparatus, module, or unit described in the embodiments can be specifically implemented by a computer chip or an entity, or can be implemented by a product having a certain function. A typical implementation device is a computer, and a specific form of the computer can be a personal computer, a laptop computer, a cellular phone, a camera phone, a smartphone, a personal digital assistant, a media player, a navigation device, an email receiving/sending device, a game console, a tablet computer, a wearable device, or a combination of any several of these devices.

In a typical configuration, the computer includes one or more central processing units (CPUs), an input/output interface, a network interface, and a memory. The memory may include a non-persistent storage, a random access memory (RAM), and/or a nonvolatile memory in a computer-readable medium, for example, a read-only memory (ROM) or a flash read-only memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD), or another optical storage, a cassette, a disk memory, a quantum memory, a graphene-based storage medium, another magnetic storage device, or any other non-transmission medium. The computer storage medium can be configured to store information that can be accessed by a computing device. Based on the definition in this specification, the computer-readable medium does not include transitory media such as a modulated data signal and carrier.

It is worthwhile to note that the terms “include”, “comprise”, or any other variants of the terms are intended to cover a non-exclusive inclusion, so that a process, a method, a product, or a device that includes a list of elements not only includes those elements but also includes other elements which are not expressly listed, or further includes elements inherent to such a process, method, product, or device. Without more constraints, an element preceded by “includes a . . . ” does not preclude the presence of additional identical elements in the process, method, product, or device that includes the element.

Example embodiments of this disclosure are described above. Other embodiments fall within the scope of this disclosure. In some cases, actions or steps described in this disclosure can be performed in a sequence different from that in the embodiments and desired results can still be achieved. In addition, the process depicted in the accompanying drawings does not necessarily need a particular sequence or continuous sequence shown to achieve the expected results. In some implementations, multi-tasking and concurrent processing are feasible or can be advantageous.

Terms used in one or more embodiments of this disclosure are merely used to describe specific embodiments, and are not intended to limit the one or more embodiments of this disclosure. The terms “a” and “the” of singular forms are also intended to include plural forms, unless otherwise specified in the context clearly. The term “and/or” indicates and includes any or all possible combinations of one or more associated listed items.

Descriptions of the terms “one embodiment”, “some embodiments”, “example”, “specific example”, or “one implementation” used in one or more embodiments of this disclosure mean that a specific feature or characteristic described with reference to this embodiment is included in at least one embodiment of this disclosure. Schematic descriptions of these terms are not necessarily with respect to the same embodiment. In addition, the described specific feature or characteristic can be combined in a proper way in one or more embodiments of this disclosure. In addition, without contradicting each other, different embodiments and specific features or characteristics in the different embodiments can be combined.

It should be understood that although terms “first”, “second”, “third”, etc. may be used in one or more embodiments of this disclosure to describe various types of information, the information is not limited to these terms. These terms are merely used to distinguish between information of the same type. For example, without departing from the scope of one or more embodiments of this disclosure, first information can also be referred to as second information, and similarly, the second information can be referred to as the first information. Depending on the context, for example, the word “if” used here can be explained as “while”, “when”, or “in response to determining”.

The descriptions are merely example embodiments in one or more embodiments of this disclosure, and are not intended to limit the embodiments of this disclosure. Any modification, equivalent replacement, improvement, etc. made without departing from the spirit and principle of the one or more embodiments of this disclosure shall fall within the protection scope of the one or more embodiments of this disclosure.

User information (including but not limited to user equipment information, personal user information, etc.) and data (including but not limited to data used for analysis, stored data, displayed data, etc.) in this disclosure are information and data that are authorized by a user or that are fully authorized by each party. Furthermore, related data needs to be collected, used, and processed in compliance with relevant laws, regulations and standards of relevant countries and regions, and corresponding operation entries are provided for the user to choose to authorize or reject.

1. A load-aware scheduling method for an inference system, applied to a global scheduler in the inference system, wherein the inference system further comprises an inference engine; the inference engine comprises at least one computing instance deployed on each computing node in a computing cluster; a computing resource of the computing instance comprises a graphics processing unit (GPU) provided on a computing node where the computing instance is located; the global scheduler maintains dynamically updated GPU load information of each computing instance; and
the method comprises:
obtaining a target inference request to be executed;
determining a target computing instance whose GPU load satisfies a predetermined condition based on the maintained GPU load information of each computing instance; and
sending the target inference request to the target computing instance, to cause the target computing instance to execute the target inference request.

2. The method according to claim 1, wherein the predetermined condition is that GPU load of the computing instance is the lowest.

3. The method according to claim 1, wherein the inference engine further comprises a local scheduler deployed on each computing node in the computing cluster; and
the sending the target inference request to the target computing instance comprises:
sending the target inference request to a target local scheduler, to cause the target local scheduler to send the target inference request to the target computing instance, wherein the target local scheduler is deployed on a computing node where the target computing instance is located.

4. The method according to claim 3, further comprising:
for each computing node, obtaining GPU load information of each computing instance on the computing node that is periodically sent by the local scheduler on the computing node based on a predetermined time period; and
updating the maintained GPU load information of each computing instance based on the obtained GPU load information.

5. The method according to claim 3, wherein the maintained GPU load information comprises instance resource utilization, wherein the instance resource utilization is an indicator calculated by the local scheduler based on GPU memory utilization and GPU memory bandwidth utilization of the computing instance, to indicate GPU load; and
the determining the target computing instance whose GPU load satisfies the predetermined condition based on the maintained GPU load information of each computing instance comprises:
determining the target computing instance with a smallest instance resource utilization based on the maintained GPU load information of each computing instance.

6. The method according to claim 5, wherein the GPU load information further comprises GPU memory utilization; and
the determining the target computing instance with the smallest instance resource utilization based on the maintained GPU load information of each computing instance comprises:
determining a candidate computing instance whose GPU memory utilization is less than a predetermined first threshold based on the maintained GPU load information of each computing instance; and
sorting the candidate computing instances based on the instance resource utilization to determine the target computing instance with the smallest instance resource utilization from the candidate computing instances.

7. The method according to claim 5, wherein the instance resource utilization is calculated based on the GPU memory utilization and the GPU memory bandwidth utilization of the computing instance by using the following formula:
$${U}_{Instance} = - 1 \times \frac{{M}_{Instance} - {U}_{Composite}}{Speed} ;$$
$${U}_{Composite} = {U}_{GPU} \times a ;$$
$$a = \{ \begin{matrix}1 + α \times \frac{t - {U}_{BW}}{t - min ( {U}_{BW} )} \\ 1 - β \times \frac{{U}_{BW} - t}{max ( {U}_{BW} ) - t}\end{matrix} ;$$
wherein U_{Instance} represents the instance resource utilization of the computing instance, M_{Instance} represents a total GPU memory size of the computing instance, U_{Composite} represents composite load of the computing instance, Speed represents the number of tokens generated by the computing instance in each iteration, U_{GPU} represents the GPU memory utilization of the computing instance, α represents a composite coefficient, α represents a predetermined first control coefficient, β represents a predetermined second control coefficient, α>β, t represents a predetermined second threshold, and U_{BW} represents the GPU memory bandwidth utilization of the computing instance.

8. The method according to claim 7, wherein the instance resource utilization of the computing instance is set to infinity when the computing instance is in a termination process.

9. A non-transitory computer-readable storage medium storing computer instructions that, when executed by a processor, cause the processor to perform the method according to claim 1.

10. An electronic device, comprising:
a processor; and
a memory storing instructions executable by the processor,
wherein the processor implements a global scheduler in an inference system; the inference system further comprises an inference engine; the inference engine comprises at least one computing instance deployed on each computing node in a computing cluster; a computing resource of the computing instance comprises a graphics processing unit (GPU) provided on a computing node where the computing instance is located; the global scheduler maintains dynamically updated GPU load information of each computing instance; and
the processor is configured to:
obtain a target inference request to be executed;
determine a target computing instance whose GPU load satisfies a predetermined condition based on the maintained GPU load information of each computing instance; and
send the target inference request to the target computing instance, to cause the target computing instance to execute the target inference request.

11. The electronic device according to claim 10, wherein the predetermined condition is that GPU load of the computing instance is the lowest.

12. The electronic device according to claim 10, wherein the inference engine further comprises a local scheduler deployed on each computing node in the computing cluster; and
in sending the target inference request to the target computing instance, the processor is further configured to:
send the target inference request to a target local scheduler, to cause the target local scheduler to send the target inference request to the target computing instance, wherein the target local scheduler is deployed on a computing node where the target computing instance is located.

13. The electronic device according to claim 12, wherein the processor is further configured to:
for each computing node, obtain GPU load information of each computing instance on the computing node that is periodically sent by the local scheduler on the computing node based on a predetermined time period; and
update the maintained GPU load information of each computing instance based on the obtained GPU load information.

14. The electronic device according to claim 12, wherein the maintained GPU load information comprises instance resource utilization, wherein the instance resource utilization is an indicator calculated by the local scheduler based on GPU memory utilization and GPU memory bandwidth utilization of the computing instance, to indicate GPU load; and
in determining the target computing instance whose GPU load satisfies the predetermined condition based on the maintained GPU load information of each computing instance, the processor is further configured to:
determine the target computing instance with a smallest instance resource utilization based on the maintained GPU load information of each computing instance.

15. The electronic device according to claim 14, wherein the GPU load information further comprises GPU memory utilization; and
in determining the target computing instance with the smallest instance resource utilization based on the maintained GPU load information of each computing instance, the processor is further configured to:
determine a candidate computing instance whose GPU memory utilization is less than a predetermined first threshold based on the maintained GPU load information of each computing instance; and
sort the candidate computing instances based on the instance resource utilization to determine the target computing instance with the smallest instance resource utilization from the candidate computing instances.

16. The electronic device according to claim 14, wherein the instance resource utilization is calculated based on the GPU memory utilization and the GPU memory bandwidth utilization of the computing instance by using the following formula:
$${U}_{Instance} = - 1 \times \frac{{M}_{Instance} - {U}_{Composite}}{Speed} ;$$
$${U}_{Composite} = {U}_{GPU} \times a ;$$
$$a = \{ \begin{matrix}1 + α \times \frac{t - {U}_{BW}}{t - min ( {U}_{BW} )} \\ 1 - β \times \frac{{U}_{BW} - t}{max ( {U}_{BW} ) - t}\end{matrix} ;$$
wherein U_{Instance} represents the instance resource utilization of the computing instance, M_{Instance} represents a total GPU memory size of the computing instance, U_{Composite} represents composite load of the computing instance, Speed represents the number of tokens generated by the computing instance in each iteration, U_{GPU} represents the GPU memory utilization of the computing instance, α represents a composite coefficient, α represents a predetermined first control coefficient, β represents a predetermined second control coefficient, α>β, t represents a predetermined second threshold, and U_{BW} represents the GPU memory bandwidth utilization of the computing instance.

17. The electronic device according to claim 16, wherein the instance resource utilization of the computing instance is set to infinity when the computing instance is in a termination process.

18. An inference system, comprising:
a global scheduler; and
an inference engine,
wherein the inference engine comprises at least one computing instance deployed on each computing node in a computing cluster; a computing resource of the computing instance comprises a graphics processing unit (GPU) provided on a computing node where the computing instance is located; the global scheduler maintains dynamically updated GPU load information of each computing instance; and
the global scheduler is configured to:
obtain a target inference request to be executed;
determine a target computing instance whose GPU load satisfies a predetermined condition based on the maintained GPU load information of each computing instance; and
send the target inference request to the target computing instance, to cause the target computing instance to execute the target inference request.
